(19) United States
(12) Patent Application Publication
(10) Pub. No.: US 2025/0283677 A1
(43) Pub. Date: Sep. 11, 2025

(54) EXPENDABLE HEAT SINK SYSTEM AND CONTROL

(71) Applicant: Eaton Intelligent Power Limited, Dublin 4 (IE)

(72) Inventors: Christopher Thomas Cantrell, Jackson, MI (US); Hongbin Wang, South Lyon, MI (US); Noah William Hemminger, Ypsilanti, MI (US)

(73) Assignee: Eaton Intelligent Power Limited, Dublin 4 (IE)

(21) Appl. No.: 19/072,163

(22) Filed: Mar. 6, 2025

Related U.S. Application Data
(60) Provisional application No. 63/562,358, filed on Mar. 7, 2024.

(51) Int. Cl. F28F 27/02; B64D 33/10

(52) U.S. Cl. CPC F28F 27/02; B64D 33/10

(57) ABSTRACT

A cooling system includes a main coolant loop through which a first type of coolant (e.g., water or glycol) circulates to cool a heat load. During normal operation, cooling of the first type of coolant is performed by a heat exchanger using ambient or ram air. During peak loads, however, cooling of the first type of coolant is supplemental using an expendable coolant (e.g., supercritical carbon dioxide, liquid helium, liquid nitrogen, etc.). The expendable coolant can be vented from the cooling system after use in cooling the first type of coolant.

### CROSS-REFERENCE PARAGRAPH

This application claims the benefit of U.S. Provisional Application No. 63/562,358, filed Mar. 7, 2024, and titled “Expendable Heat Sink System and Control,” the disclosure of which is hereby incorporated herein by reference in its entirety.

### BACKGROUND

Various components within an aircraft require thermal management to operate. For example, a propeller motor and a battery powering the propeller motor both generate heat during operation and can overheat (surpass an upper temperature limit) if left uncooled. Overheating may lead to electrical fires, equipment damage, performance, or useful life degradation. Certain components, such as the battery, also may have a lower temperature limit to operate properly. Accordingly, the aircraft is equipped with a thermal management system including cooling circuits for these components.

### SUMMARY

Aspects of the disclosure are directed to a cooling system utilizing expendable media. In certain implementations, the cooling system can be used on an aircraft, such as a hybrid electric aircraft or electric aircraft. Other implementations are possible.

In certain aspects, expendable media is selectively released to cool a non-expendable coolant during peak heat loads. During non-peak heat loads, the non-expendable coolant is cooled using conventional means (e.g., ambient air). Because the expendable media acts as a thermal sink during peak heat loads, the non-expendable coolant and corresponding components need only be designed to accommodate normal operating loads, leading to smaller and lighter components.

In certain aspects, a first type of coolant is circulating along a main coolant loop to cool a heat load. The first type of coolant is cooled at an air-to-liquid heat exchanger. During select periods, the first coolant is diverted to a liquid-to-liquid heat exchanger at which the first type of coolant is cooled by a second type of coolant having a greater specific heat capacity. Because the second coolant cools only the first coolant and not the heat load directly, the components forming the heat load need not be designed to handle the pressure, temperature, or other characteristics of the second coolant.

In some implementations, the first type of coolant is directed back to the cooling circuit upstream of the air-to-liquid heat exchanger. In other implementations, the first type of coolant is directed back to the cooling circuit downstream of the air-to-liquid heat exchanger.

In some implementations, the second type of coolant is vented towards the air-to-liquid heat exchanger to further cool the first type of coolant. In other implementations, the second type of coolant is vented to ambient.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a schematic diagram of a cooling system configured to be supplemented by an expendable media cooling circuit, the expendable media cooling circuit being integrated with the cooling system in a first configuration to supplement cooling of an air-to-liquid heat exchanger;

FIG. 2 shows a flow path through the cooling system of FIG. 1 during normal operation;

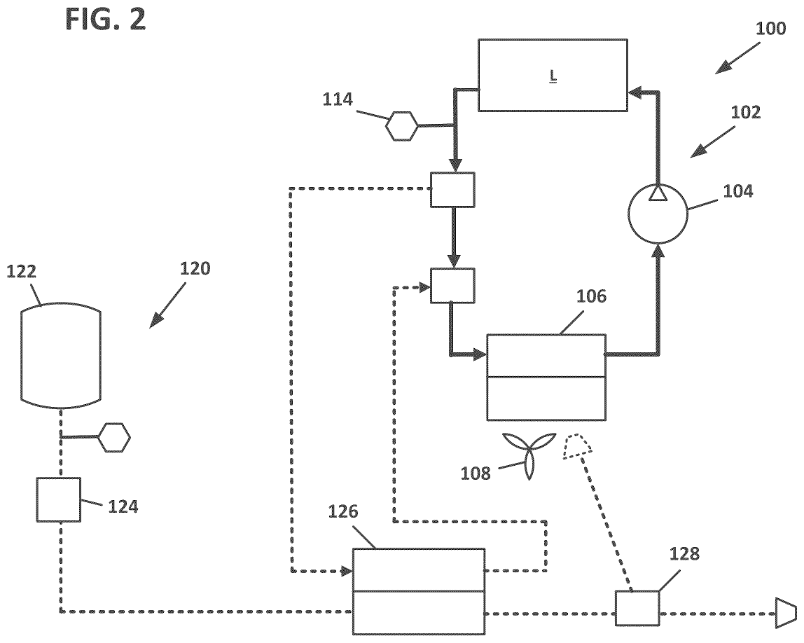

FIG. 3 shows a flow path through the cooling system and expendable media cooling circuit of FIG. 1 during peak heat loads;

FIG. 4 shows an optional configuration in which the expendable media is vented towards the cooling system;

FIG. 5 is a schematic diagram of a cooling system configured to be supplemented by an expendable media cooling circuit, the expendable media cooling circuit being integrated with the cooling system in a second configuration to replace the air-to-liquid heat exchanger;

FIG. 6 shows a flow path through the cooling system of FIG. 5 during normal operation; and

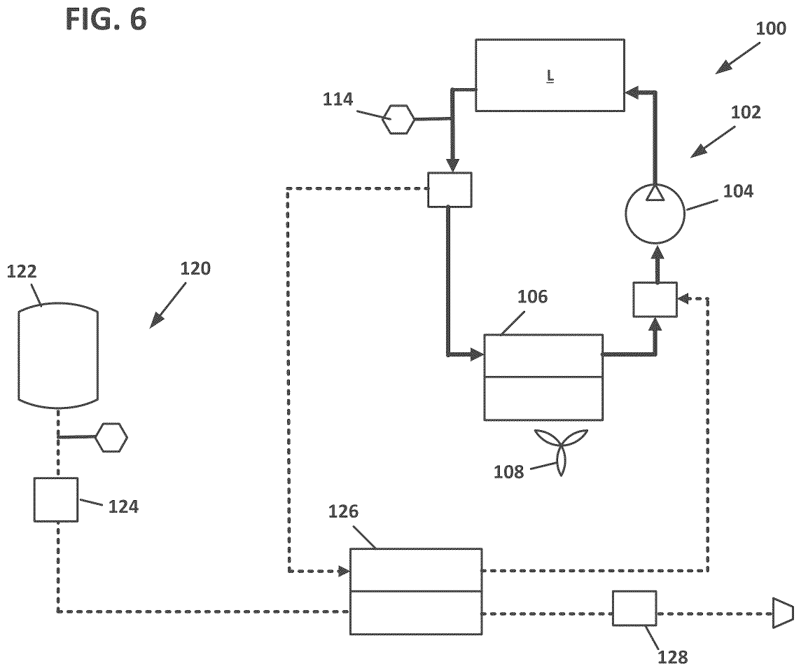

FIG. 7 shows a flow path through the cooling system and expendable media cooling circuit of FIG. 5 during peak heat loads.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

Referring to the figures in general, a cooling system 100 includes a main coolant loop 102 and a supplemental coolant path 120. The main coolant loop 102 is configured to circulate a first coolant past a heat load L. The main coolant loop 102 includes a coolant pump 104 and a first heat exchanger 106 (e.g., an air-to-liquid heat exchanger) at which heat is removed from the first coolant. For example, ambient air or ram air 108 may be blown over the first exchanger 106 to cool the first coolant.

The supplemental coolant path 120 includes a tank 122 and a second heat exchanger 126. In certain implementations, the second heat exchanger 126 is a liquid-to-liquid heat exchanger. As the term is used herein, a liquid-to-liquid heat exchanger cools a first liquid coolant using a second coolant that is either liquid or in a supercritical state. The tank 122 holds a second coolant EC having a specific heat capacity that is greater than the specific heat capacity of the first coolant. In other words, the second coolant is capable of absorbing a greater amount of heat than the first coolant for a given time period. The supplemental coolant path 120 includes a valve arrangement 124 to selectively release the second coolant EC from the tank 122. In some implementations, the valve arrangement 124 is located at the tank 122. In other implementations, the valve arrangement 124 is downstream of the tank 122.

In some implementations, the second coolant EC is held in a liquid state within the tank 122. In certain implementations, a valve arrangement 124 and/or a valve arrangement 128 operates to release the second coolant EC from the tank 122 and to ensure a desired phase of the second coolant EC. For example, the valve arrangement 128 controls when the second coolant EC is vented from the supplemental coolant path 120. By remaining closed, the pressure within the supplemental coolant path 120 increases, which may bring the second coolant EC to a supercritical state.

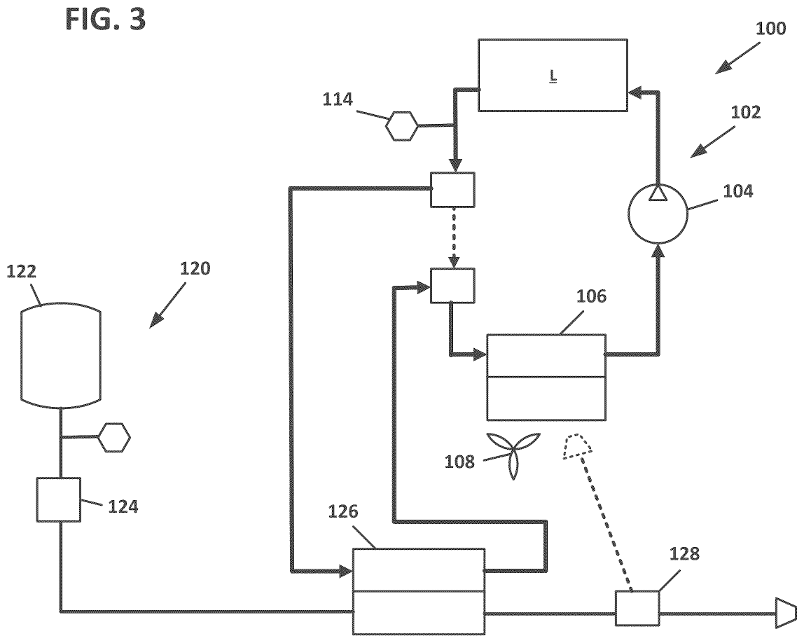

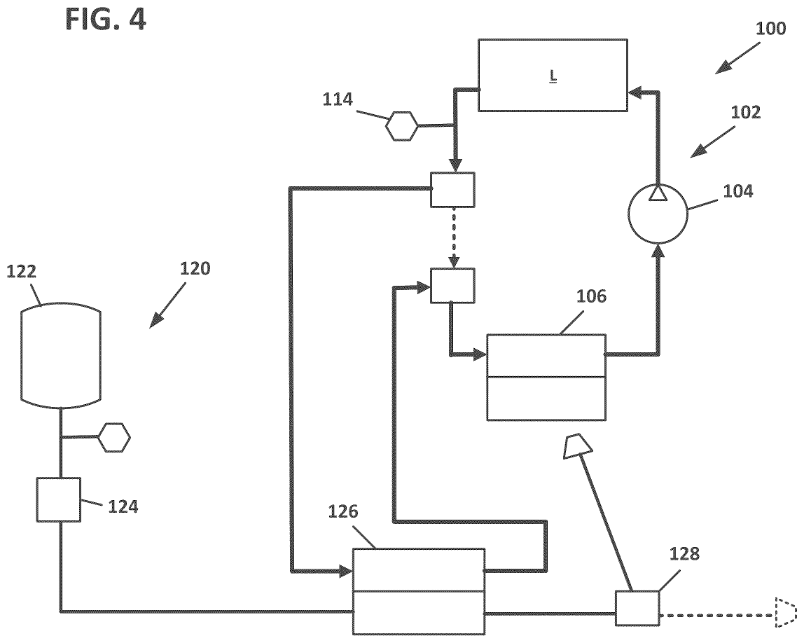

The supplemental coolant path directs the released second coolant through the second heat exchanger 126. In certain implementations, the second coolant EC is vented out of the cooling system 100 after passing through the second heat exchanger 126. For example, the valve arrangement 128 may intermittently vent the second coolant EC. In some examples, the second coolant EC is vented to ambient (e.g., see FIG. 3). In other examples, the second coolant EC is vented towards the first heat exchanger 106 to act as ram air (e.g., see FIG. 4).

A valve arrangement 110, 110′ is configured to selectively route the first coolant of the main coolant loop 102 to the second heat exchanger 126 of the supplemental coolant path 120 to be cooled by the second coolant EC. The valve arrangement 110, 110′ includes a first valve 111 that selectively directs the first coolant either towards the second heat exchanger 126 or towards the first heat exchanger 106. In certain implementations, the valve arrangement 110, 110′ also includes a second valve 112, 112′ that receives the first coolant after the first coolant has been cooled at the second heat exchanger 126. The second valve 112, 112′ integrates the cooled first coolant back into the main coolant loop 102.

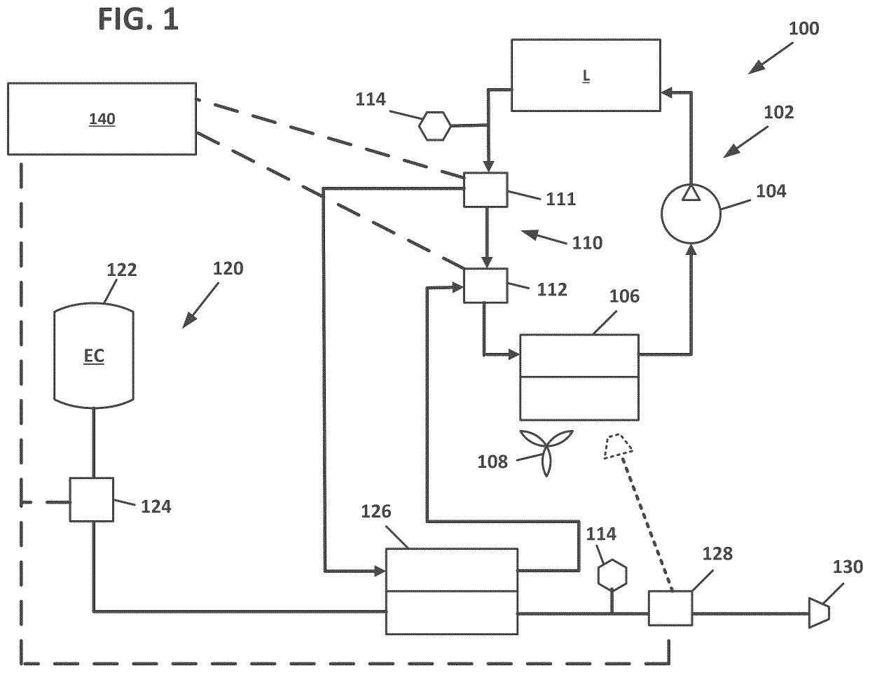

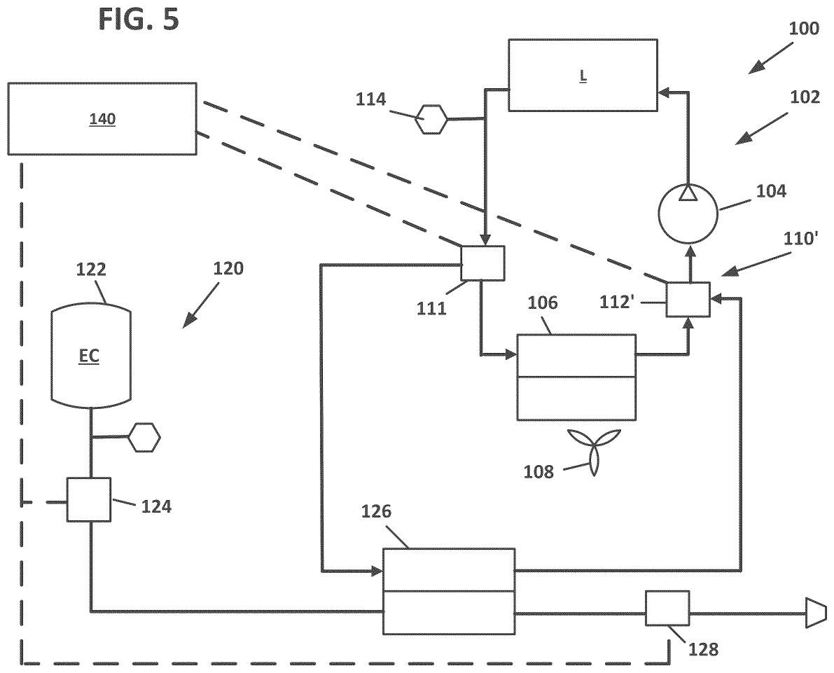

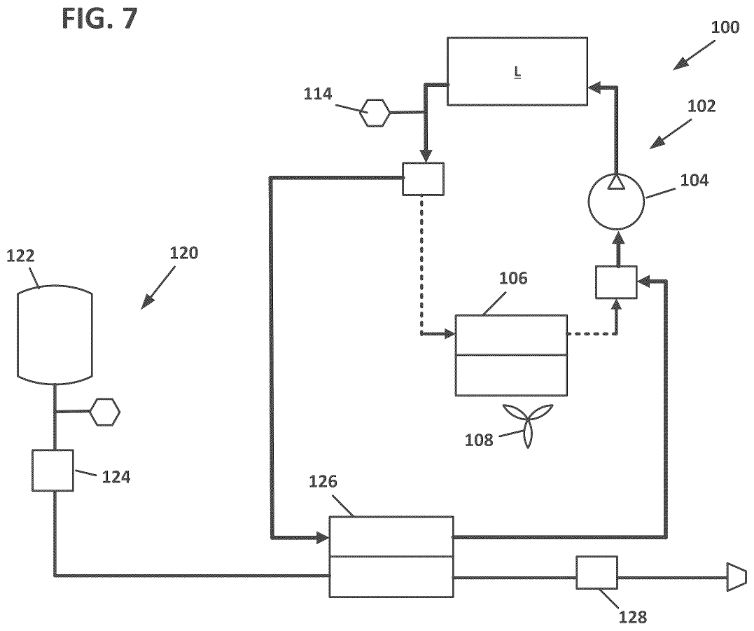

In some implementations, the second valve 112 is located upstream of the first heat exchanger 106 (e.g., see FIG. 1). In such implementations, the cooled first coolant is routed through the first heat exchanger 106 for further cooling (e.g., see FIG. 3). In other implementations, the second valve 112′ is located downstream of the first heat exchanger 106 (e.g., see FIG. 5). In such implementations, the cooled first coolant bypasses the first heat exchanger 106 before heading to the heat load L (e.g., see FIG. 7). In still other implementations, the first coolant is directed back into the main coolant loop 102 without a separate valve.

Suitable examples of a first type of coolant include water, ethylene glycol, or propylene glycol. Suitable examples of a second type of coolant EC include supercritical carbon dioxide (sCO₂), liquid hydrogen (LH₂), and liquid nitrogen (LN₂). In certain implementations, the second coolant has a specific heat capacity that is substantially greater than the specific heat capacity of the first coolant. For example, the second coolant may have a specific heat capacity that is 2 times, 5 times, 10 times, 20 times, or 30 times the specific heat capacity of the first coolant at a particular temperature.

In certain implementations, the second coolant is maintained at a higher pressure than the first coolant. Accordingly, components of the main coolant loop 102 need not be built to withstand the pressure levels of the second coolant.

In certain examples, the first heat exchanger 106 has a plate/fin (PFHE) construction. In certain examples, the second heat exchanger 126 includes a stacked plate heat exchanger.

In certain implementations, a controller 140 manages operation of the valve arrangement 110. In certain examples, the controller 140 manages operation of the first valve 111 to selectively direct the first coolant towards the second heat exchanger 126. In certain examples, the controller 140 manages operation of the second valve 112, 112′ that selectively releases the second coolant EC from the tank 122. In certain examples, the controller 140 manages operation of the valve arrangement 124 that selectively releases the second coolant EC from the tank 122.

In certain implementations, the controller 140 manages the operation of the valve arrangements 110, 124 based on one or more characteristics of the first and second coolants. In certain implementations, one or more sensors 114 (e.g., temperature sensor, pressure sensor, etc.) are disposed throughout the main coolant loop 102 and/or the supplemental coolant path 120. In certain examples, the controller 140 will open the valve 124 of the supplemental coolant path 120 to release the second coolant EC from the tank 122 towards the second heat exchanger 126. In certain examples, the controller 140 may configure the valve arrangement 110 to direct the first coolant towards the second heat exchanger 126 based on a temperature reading of the first coolant taken by a temperature sensor 114 along the main coolant path 102.

In some examples, the controller 140 may operate the first valve 111 to direct the first coolant towards the second heat exchanger 126 when the temperature of the first coolant exceeds a predetermined level. For example, the first coolant may be directed towards the second heat exchanger 126 when the temperature of the first coolant reaches 35 degrees Celsius, 40 degrees Celsius, 45 degrees Celsius, 50 degrees Celsius, 60 degrees Celsius, 70 degrees Celsius, 80 degrees Celsius, or 85 degrees Celsius. In other examples, the controller 140 may operate the first valve 111 to direct the coolant towards the second heat exchanger 126 when the heat load L reaches a predetermined level (e.g., 35, 40, 45, 50, 60, 70, 80, or 85 degrees Celsius).

In certain examples, the controller 140 may configure the valve arrangement 128 to direct the second coolant EC leaving the second heat exchanger 126 towards the first heat exchanger 106 when the temperature of the second coolant EC remain below a predetermined threshold and/or when the temperature of the first coolant rises above a predetermined threshold. For example, a temperature sensor 114 may be disposed downstream of the second heat exchanger 126 along the supplemental coolant path 120. If the second coolant EC leaving the second heat exchanger 126 is sufficiently cold, then the second coolant EC may be vented at the first heat exchanger 106 as ram air to further cool the first coolant. In certain examples, the second coolant EC may be vented to the first heat exchanger 106 if suitable ram air is not available (e.g., if ambient air temperatures are too high). Alternatively, if the temperature of the second coolant EC leaving the second heat exchanger 126 is too high and/or if the temperature of the first coolant is below a predetermined threshold, then the controller 140 may configure the valve arrangement 128 to vent the second coolant EC to ambient.

Example implementations of the disclosure are further described in the below aspects.

Aspect 1. A cooling system comprising:
a main coolant loop configured to circulate a first coolant having a first specific heat capacity, the main coolant loop including a coolant pump and a first heat exchanger, the main coolant loop extending past a heat load;
a supplemental coolant path including a tank and a second heat exchanger, the tank holding a second coolant having a second specific heat capacity that is greater than the first specific heat capacity of the first coolant; and
a valve arrangement configured to selectively route the first coolant of the main coolant loop to the second heat exchanger of the supplemental coolant path to be cooled by the second coolant.

Aspect 2. The cooling system of aspect 1, wherein the valve arrangement is configured to route the first coolant back to the main coolant loop upstream of the first heat exchanger after being cooled by the second heat exchanger.

Aspect 3. The cooling system of aspect 1, wherein the valve arrangement is configured to route the first coolant back to the main coolant loop downstream of the first heat exchanger after being cooled by the second heat exchanger.

Aspect 4. The cooling system of any of aspects 1-3, wherein the second coolant is vented after flowing through the second heat exchanger.

Aspect 5. The cooling system of aspect 4, wherein the vented second coolant is directed toward the first heat exchanger to cool the first coolant.

Aspect 6. The cooling system of any of aspects 1-5, further comprising a controller configured to operate the valve arrangement.

Aspect 7. The cooling system of aspect 6, wherein the controller operates the valve arrangement based on a temperature of the first coolant.

Aspect 8. The cooling system of aspect 6, wherein the controller operates a valve arrangement of the supplemental coolant path to selectively release the second coolant to the second heat exchanger.

Aspect 9. The cooling system of aspect 6, wherein the controller operates a valve arrangement of the supplemental coolant path to selectively vent the second coolant.

Aspect 10. The cooling system of any of aspects 1-9, wherein the first heat exchanger is an air-to-liquid heat exchanger and wherein the second heat exchanger is a liquid-to-liquid heat exchanger.

Aspect 11. A method of cooling a heat load, the method comprising:
circulating a first coolant between the heat load and a first heat exchanger along a main coolant loop;
determining that the first heat exchanger is not sufficiently cooling the first coolant;
redirecting the first coolant to a second heat exchanger;
directing a second coolant to the second heat exchanger, the second coolant being colder than the first coolant; and
directing the first coolant back to the main coolant loop for further circulation.

Aspect 12. The method of aspect 11, further comprising venting the second coolant.

Aspect 13. The method of aspect 12, wherein venting the second coolant comprises venting the second coolant to ambient.

Aspect 14. The method of aspect 12, wherein venting the second coolant comprises venting the second coolant towards the first heat exchanger.

Aspect 15. The method of aspect 11, wherein the second coolant has a greater specific heat capacity than the first coolant.

Aspect 16. The method of aspect 11, wherein determining that the first heat exchanger is not sufficiently cooling the first coolant comprises analyzing a temperature reading of the first coolant obtained along the main coolant loop.

Aspect 17. A cooling system for a heat load, the cooling system comprising:
a main coolant loop configured to circulate a non-expendable coolant, the main coolant loop including a coolant pump and a first heat exchanger, the main coolant loop circulating the non-expendable coolant past the heat load;
a supplemental coolant path including a tank holding an expendable coolant, the supplemental coolant path also including a second heat exchanger through which the expendable coolant is selectively directed; and
a controller configured to manage releasing of the expendable coolant to the second heat exchanger and configured to manage redirecting the non-expendable coolant to the second heat exchanger.

Aspect 18. The cooling system of aspect 17, further comprising a plurality of sensors disposed along the main coolant loop and the supplemental coolant path.

Aspect 19. The cooling system of aspect 17, further comprising a first valve arrangement configured to manage a selective connection between the main coolant loop and the supplemental coolant path, wherein the controller manages operation of the first valve arrangement.

Aspect 20. The cooling system of any of aspects 17-19, further comprising a second valve arrangement configured to manage selective venting of the expendable coolant, wherein the controller manages operation of the second valve arrangement.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

What is claimed is:

1. A cooling system comprising:
a main coolant loop configured to circulate a first coolant having a first specific heat capacity, the main coolant loop including a coolant pump and a first heat exchanger, the main coolant loop extending past a heat load;
a supplemental coolant path including a tank and a second heat exchanger, the tank holding a second coolant having a second specific heat capacity that is greater than the first specific heat capacity of the first coolant; and
a valve arrangement configured to selectively route the first coolant of the main coolant loop to the second heat exchanger of the supplemental coolant path to be cooled by the second coolant.

2. The cooling system of claim 1, wherein the valve arrangement is configured to route the first coolant back to the main coolant loop upstream of the first heat exchanger after being cooled by the second heat exchanger.

3. The cooling system of claim 1, wherein the valve arrangement is configured to route the first coolant back to the main coolant loop downstream of the first heat exchanger after being cooled by the second heat exchanger.

4. The cooling system of claim 1, wherein the second coolant is vented after flowing through the second heat exchanger.

5. The cooling system of claim 4, wherein the vented second coolant is directed toward the first heat exchanger to cool the first coolant.

6. The cooling system of claim 1, further comprising a controller configured to operate the valve arrangement.

7. The cooling system of claim 6, wherein the controller operates the valve arrangement based on a temperature of the first coolant.

8. The cooling system of claim 6, wherein the controller operates a valve arrangement of the supplemental coolant path to selectively release the second coolant to the second heat exchanger.

9. The cooling system of claim 6, wherein the controller operates a valve arrangement of the supplemental coolant path to selectively vent the second coolant.

10. The cooling system of claim 1, wherein the first heat exchanger is an air-to-liquid heat exchanger and wherein the second heat exchanger is a liquid-to-liquid heat exchanger.

11. A method of cooling a heat load, the method comprising:
circulating a first coolant between the heat load and a first heat exchanger along a main coolant loop;
determining that the first heat exchanger is not sufficiently cooling the first coolant;
redirecting the first coolant to a second heat exchanger;
directing a second coolant to the second heat exchanger, the second coolant being colder than the first coolant; and
directing the first coolant back to the main coolant loop for further circulation.

12. The method of claim 11, further comprising venting the second coolant.

13. The method of claim 12, wherein venting the second coolant comprises venting the second coolant to ambient.

14. The method of claim 12, wherein venting the second coolant comprises venting the second coolant towards the first heat exchanger.

15. The method of claim 11, wherein the second coolant has a greater specific heat capacity than the first coolant.

16. The method of claim 11, wherein determining that the first heat exchanger is not sufficiently cooling the first coolant comprises analyzing a temperature reading of the first coolant obtained along the main coolant loop.

17. A cooling system for a heat load, the cooling system comprising:
a main coolant loop configured to circulate a non-expendable coolant, the main coolant loop including a coolant pump and a first heat exchanger, the main coolant loop circulating the non-expendable coolant past the heat load;
a supplemental coolant path including a tank holding an expendable coolant, the supplemental coolant path also including a second heat exchanger through which the expendable coolant is selectively directed; and
a controller configured to manage releasing of the expendable coolant to the second heat exchanger and configured to manage redirecting the non-expendable coolant to the second heat exchanger.

18. The cooling system of claim 17, further comprising a plurality of sensors disposed along the main coolant loop and the supplemental coolant path.

19. The cooling system of claim 17, further comprising a first valve arrangement configured to manage a selective connection between the main coolant loop and the supplemental coolant path, wherein the controller manages operation of the first valve arrangement.

20. The cooling system of claim 17, further comprising a second valve arrangement configured to manage selective venting of the expendable coolant, wherein the controller manages operation of the second valve arrangement.
